(19) United States
(12) Patent Application Publication
(10) Pub. No.: US 2009/0177352 A1
(43) Pub. Date: Jul. 9, 2009

(54) System and Method for Motor Vehicle Diagnosis and Vehicle Reception

(75) Inventors: Gerald Grau, Waiblingen (DE); Manuel Rieger, Fellbach (DE); Markus Scholz, Winnenden (DE); Ralf Traub, Stuttgart (DE); Klaus Weiss, Gruibingen (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLER AG, STUTTGART (DE)

(21) Appl. No.: 12/280,964

(22) PCT Filed: Feb. 8, 2007
(86) PCT No.: PCT/EP2007/001063

§ 371 Date: Dec. 19, 2008

(30) Foreign Application Priority Data
Feb. 28, 2006 (DE) 10 2006 009 098.5

(51) Int. Cl. G01M 17/00

(52) U.S. Cl. 701/33

(57) ABSTRACT

A vehicle diagnosis system for ascertaining, storing and transmitting diagnosis data from control units in a motor vehicle to a computer outside of the motor vehicle has components which are inside of the vehicle and components which are outside of the vehicle. The onboard components are capable of autonomously requesting diagnosis data from control units, buffer-storing the diagnosis data and of transmitting the diagnosis data to offboard components. The offboard components can be used to configure the onboard components, to visually display the transmitted data and to forward said data to subsequent systems. Access is effected using a communication module, which is preferably implemented in a diagnosis control unit with a dedicated gateway and which is not the control unit for the central locking. A gateway for diagnosis applications is present in the vehicle in the case of vehicles with a diagnosis CAN bus or with another diagnosis bus.

### BACKGROUND AND SUMMARY OF THE INVENTION

This application is a national stage of PCT International Application No. PCT/WO2007/098844, filed Sep. 7, 2007, which claims priority under 35 U.S.C. § 119 to German Patent Application No. 10 2006 009 098.5, filed Feb. 28, 2006, the disclosure(s) of which is (are) expressly incorporated by reference herein.

The invention relates to a motor vehicle diagnosis system and method for ascertaining, storing and transmitting diagnosis data from control units in a motor vehicle to a computer outside of the motor vehicle. In one embodiment, the system comprises components which are inside of the vehicle and components which are outside of the vehicle. The onboard components may be configured for autonomously requesting diagnosis data from control units, buffer-storing the diagnosis data and transmitting the diagnosis data to the offboard components. The offboard components can be used to configure the onboard components, to visually display the transmitted data and to forward the transmitted data to subsequent systems.

German Patent Document DE 10323384 A1, discloses a remote diagnosis system (telediagnosis system) in which vehicle data is transmitted to a remote diagnosis center to be processed and assessed. These remote diagnosis systems are directly intended for fleet operators, call center applications for a fleet operator, other service garages or a vehicle driver.

Vehicle communications systems (telematics applications in the vehicle) are also known. For example, German Patent Document DE 196 25 002 B4 discloses a communication system including a flow controller used to access various control units in the vehicle (with different applications) via an air interface and a gateway in the vehicle. The individual control units are networked to the gateway by one or more communication buses, which may be different, and associated bus protocols. The remote computer connects to the gateway using a mobile radio system with data capability (e.g., GSM system). Connection setup from the remote computer (via the gateway) to a selected application control unit is provided by an adaptive application controller in the remote computer. A selection code (telephone number of the GSM service) is used for access control and identification of the telematics platform to be addressed in the vehicle. In addition, a GPS receiver may be installed in the vehicle and networked to the gateway, so that the telematics platform can be used for remote position finding for the vehicle. The communication architecture for the connection setup is designed in accordance with the ISO/OSI layer model, so that the connection setup can be made independent of the applications and conversely the applications can be made independent of the connection setup. Thus many applications can be used via the communication link.

German Patent Document DE 199 32 668 A1 discloses accessing control units in a vehicle for telediagnosis applications using mobile radio, in which access involves reprogramming the control units using remote flashing. In particular, a data format and data conversion are disclosed, which convert a mobile radio standard to a KWP2000 format and vice versa. In this case the data format for the control unit communication comprises a header, useful data and a checksum, in a manner which is known per se.

The above identified telediagnosis systems handle exclusively connection setup, data download and remote-controlled diagnosis from a diagnosis center equipped specifically for this purpose. However, the aforementioned diagnosis systems do not take account of or provide any additional assistance for the aspects of vehicle reception in a service garage.

European Patent Document EP 0895198 and German Patent Document DE 195 45 888 A1, to BMW, disclose assistance for a garage boss in and during vehicle reception, in which a vehicle driver surrenders a transponder key for remote-controlled central locking of the vehicle at a service garage's vehicle reception. The transponder key is put into a reader and the key identifier is read. A separate transmitter (operating on the frequency of the central locking system) is used to transmit the key identifier to the central locking gateway, and to wake up control units in a parked motor vehicle. Thus, it may then be possible to use a mobile radio link to read diagnosis data from the a motor vehicle's control units into a diagnosis tester in the garage using a telediagnosis system as discussed above. Further, diagnosis data can be read at the repair reception.

A common feature of the above-identified telediagnosis processes is that the vehicle control units are in an activated states telediagnosis. However, for parked vehicles at a vehicle reception in a service garage, it is not readily possible to use telediagnosis, which may already be implemented in the vehicle, to access the control units of the parked vehicles. Known telediagnosis systems have difficulty with identification of vehicles and addressing a correct vehicle. Pure position finding using a GPS system may be too inaccurate (to achieve accurate identification from the vehicle reception via a radio interface) when vehicles are parked next to one another in the yard at the service garage. A solution to these problems provided by the aforementioned two BMW Patent Documents includes setting up contact via the control unit for the door locking and the identifier using the transponder key. The identifier is read using a reader at the vehicle reception.

One object of the present invention is to provide an alternative solution for application at the vehicle reception which does not require a transponder key.

These and other objects of the invention are achieved by the motor vehicle diagnosis system according to the invention, which provides for ascertaining, storing and transmitting diagnosis data from control units in a motor vehicle to a computer outside of the motor vehicle. The system comprises components which are inside of the vehicle and components which are outside of the vehicle. The onboard components are capable of autonomously requesting diagnosis data from control units, buffer-storing the diagnosis data and transmitting the diagnosis data to the offboard components. The offboard components can be used to configure the onboard components, to visually display the transmitted data and to forward said data to subsequent systems. Access may be effected using a communication module, which is preferably implemented in a diagnosis control unit with a dedicated gateway and which is not the control unit for the central locking. A gateway for diagnosis applications is present in the vehicle in the case of vehicles with a diagnosis CAN bus or with another diagnosis bus. The communication module is either continually on reception standby or is on reception standby at least during an arranged time interval. An identifier is may be input into the communication module in advance of the visit to the garage. During the actual visit to the garage, this identifier is used to set up a connection from an offboard communication module via a dedicated channel. In this case, the connection request is accepted only by the vehicle whose onboard communication module has the correct identifier.

If the onboard communication module does not continually need to be on reception standby, the onboard communication module can be activated upon input of the identifier into the module. The onboard module can then remains active at least until a connection has been set up.

In addition to a vehicle identifier, a fixed time window can be arranged within which the connection needs to be set up. The identifier may already contain this time window by virtue of a date statement and a time statement. In this case, the onboard communication module may be configured to be activated exactly for the arranged time window. However, as a result, the time window would also need to be input to the offboard communication system, and connection setup would be possible only during the time window.

Alternatively, a unique identifier can be arranged for each garage visit, in which the identifier then loses its validity when a connection has been set up and when the useful data has been transmitted.

The identifier may be delivered or provided to the customer during the first contact between the garage and the customer, which usually involves a telephone call to arrange an appointment. The customer can then input the identifier into the onboard communication module. If the customer forgets to input the identifier, the identifier can also be input at the last minute (when the motor vehicle is already at or in the garage, or in the vehicle reception).

Alternatively, the offboard communication module also transmits an identifier. The identifier may be transmitted and stored in the onboard communication module a the connection has been established. The identifier may be valid for a relatively long period and may be provided with a validity date or an expiry date. The onboard system includes a request function to provide a history of contacts made in the past. For example, a respective stipulated number of transmitted identifiers for an offboard platform from past contact is also stored. When an offboard communication module (which is already known in this way) attempts to set up a connection, connection setup is permitted by the onboard communication module without further confirmation in the vehicle, (provided that the stored identifiers are still available and also still valid). This allows, by way of example, a service garage to check the success of the service carried out (following a visit to the garage, afterwards when the customer is driving the vehicle again). Authorized connection setup for offboard communication modules, or service stations, which are already known is also of interest to vehicle manufacturers for obtaining field data from the vehicles of their vehicle fleets.

It is therefore also possible for a specific identifier of an offboard communication module to be stored in the onboard communication module of the vehicle during the actual production of the vehicle. An identifier would then not need to be arranged with the vehicle driver and delivered to him. An authorized repair garage could be provided with the identifier for the offboard communication module by the vehicle manufacturer upon request to automatically set up a connection to the manufacturer's offboard communication module. However, this would possibly require that the onboard diagnosis modules of the vehicle to be addressed be ready to receive (which is achieved by the onboard communication modules in all vehicles being permanently on reception standby or by an arrangement being made with the customer as to when his vehicle is in operation), so that the onboard communication module is on reception standby during operation of the vehicle. Further the module can be used to access the control units, which are then likewise awake.

In alternative embodiment, dynamic management can be carried out for the identifiers stored in the vehicle in which the identifier stored in the vehicle is then replaced by a new identifier upon each visit to a garage. The replacement is made during a connection protected by the old identifier. This requires dynamic management and allocation of the identifiers for the authorized repair garages by a central manager.

To set up a connection between the onboard communication module and the offboard communication module on the premises of an authorized repair garage, a WLAN (Wireless Local Area Network) connection is preferably used for the separate channel that is required between the two communication modules. Depending on the embodiment of the remote diagnosis system, when the connection has been set up, the useful data can then be downloaded via the WLAN connection, or connection paths already set up for remote diagnosis systems in the prior art are activated via mobile radio links and used for the data transfer. The latter comes into consideration for vehicles which have an appropriate remote diagnosis system, which is frequently the case with commercial vehicles. The former alternative is of particular interest for private motor cars, since remote diagnosis systems are generally not implemented.

Other objects, advantages and novel features of the present invention will become apparent from the following detailed description of the invention when considered in conjunction with the accompanying drawings.

### BRIEF DESCRIPTION OF THE DRAWINGS

FIG. 1 is a graphical overview with the logical components of the invention; and

FIG. 2 is an illustration of a layer model for the communication modules involved.

### DETAILED DESCRIPTION OF THE DRAWINGS

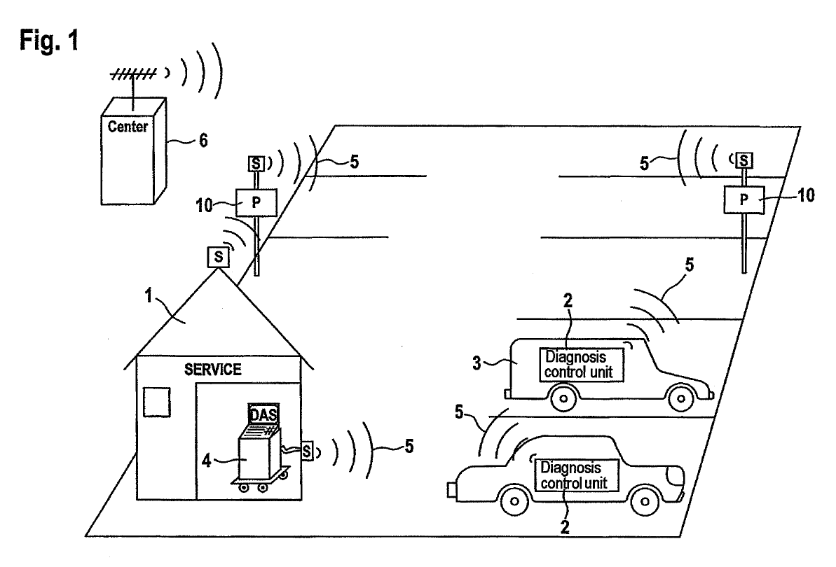

As shown in FIG. 1, a graphical overview of components of one embodiment of the invention and their interaction in an application for vehicle reception in a service garage 1. This flexible asynchronous remote diagnosis system is a technical system for ascertaining, storing and transmitting diagnosis data from individual control units 2 of vehicle 3 to computer 4 in the service garage via a communication channel 5.

The system comprises components which are inside of the vehicle and components which are outside of the vehicle. The onboard components are capable of autonomously requesting diagnosis data from control units in the vehicle, of buffer-storing the diagnosis data and transmitting the diagnosis data to the offboard components. The offboard components can be used to configure the onboard components, to visually display the transmitted data and to forward the diagnosis data to subsequent systems in the process chain.

The computer in the service garage may be a central server in the garage or the service tester which is used for direct diagnosis for the motor vehicles. Preferably, at least one of these two computers can be connected additionally to a diagnosis center 6. The central diagnosis center is configured to distribute diagnosis software and updates for the vehicle, fleet information and new versions of diagnosis software for changes to models in the vehicle fleet. The diagnosis center may be important for some exemplary embodiments of the invention when identifiers of the access authorizations are being managed centrally. It is then necessary to provide an opportunity for a communication link between the diagnosis tester and the central diagnosis center for the purpose of allocating and monitoring identifiers.

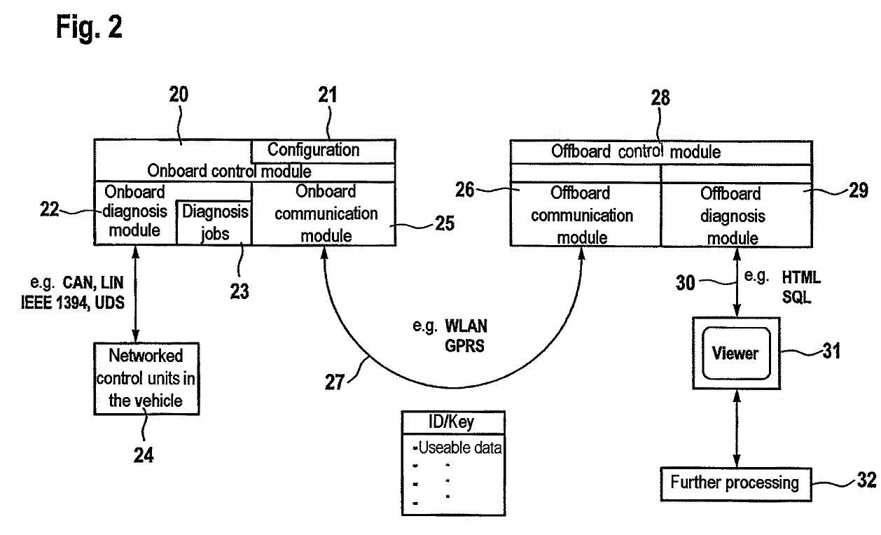

FIG. 2 shows the basic design of an onboard control module 20 according to one embodiment of the invention. Onboard control module 20 is implemented in a diagnosis control unit 2 in the motor vehicle. The diagnosis control unit also serves as a gateway for accessing other networked control units in the motor vehicle. The onboard control module 20 can contain all of the processing logic of the invention in the vehicle for application in a service garage's customer reception. All the relevant onboard components may be controlled by this module.

Configuration interface 21 can be used to stipulate conditions for accessing the onboard control module. By way of example, this can be used to store when diagnosis data is permitted to be requested, when result data is permitted to be transmitted to the offboard components, and in particular it can be used to input and store identifiers.

The configuration allows for other constraints, such as chronological to be stipulated. One example is how frequently and upon what external influence it is necessary to perform diagnosis jobs. Time windows for access may also be stipulated here.

It is also possible to stipulate the access conditions for software download to the control units for the motor vehicle's onboard power supply.

Access to the subsequent services in the motor vehicle and to onboard control module 20 is possible only when the control module is in the activated state. An activated control module can be used to wake up and activate the subsequent services and the control units in the motor vehicle.

Following activation by the control module, the onboard diagnosis module 22 is able to process diagnosis jobs 23, autonomously request information stipulated in diagnosis jobs by the individual control units 24, and store the result. In the diagnosis jobs, different requests can be made on the based on a first result. The onboard diagnosis module can communicate with the control units in the vehicle by means of different diagnosis protocols (e.g., UDS, KWP2000, etc.) using different media (e.g., IEEE1394, CAN bus, LIN bus, Flexray™, etc.).

A diagnosis job comprises a collection of instructions which can be executed via the onboard diagnosis module. In this case it is possible to distinguish groups of instructions which are executed once at the beginning, which are executed once at the end, and which are executed for a group of control units. Depending on the result, the flow of the diagnosis job can branch in different directions.

Following activation by the control module, the onboard communication module 25 transmits the result data from the diagnosis module to the offboard system using suitable media (e.g. Ethernet; GSM/CSD; GSM/GPRS; WLAN; UMTS; Bluetooth, etc.). In this case, the mechanisms for safeguarding connection setup (e.g., authentication, ID) and data transmission (e.g., encryption) are also stored here. In addition, this can be used to transmit updated configurations for onboard control module 20 and diagnosis jobs for onboard diagnosis module 22. In particular, it is also possible to transmit identifiers for offboard communication module 26 to onboard communication module 25 and configuration interface 26, and to store them.

Offboard communication module 26 is the counterpart of onboard communication module 25 and interchanges data with it bidirectionally via the respectively chosen communication link 27.

The diagnosis jobs' result data transmitted from the onboard diagnosis module are forwarded by the offboard communication module 26 and processed further by subsequent services.

Control of the distribution is undertaken by an offboard control module 28 which controls the transmission of new configurations and of new diagnosis software to the vehicle. In addition, offboard control module 28 manages the result data and transfers the result data for further processing to an offboard diagnosis module 29. The offboard control module 28 is therefore preferably implemented together with the offboard communication module 26 and with the offboard diagnosis module 29 in the service garage's diagnosis tester 4.

Should the diagnosis capabilities of offboard diagnosis module 29, (the diagnosis tester 4 in the garage) be inadequate, it is possible for the diagnosis data to be forwarded to more powerful post-processing systems via interfaces 30. This further processing 32 can take place in a diagnosis center 6, for example. There, diagnosis data and diagnosis results obtained are displayed to a diagnosis expert on a viewer 31. A suitable data format the further processing 32 and for the transmission is the HTML (Hyper Text Markup Language) or SQL (Structured Query Language) format.

Thus, the following advantages may be provided. The vehicle permanently contains a fixed subsystem of a total diagnosis system which can autonomously access diagnosis information in individual control units. All the information required for this purpose is available to the diagnosis system in the vehicle. The onboard diagnosis system can perform diagnosis jobs without communicating with another diagnosis subsystem 5. Additionally, results of the diagnosis requests are buffer-stored and are transmitted at a suitable time.

Diagnosis jobs can be transmitted and updated from the offboard to the onboard system to allow for diagnosis of new or other control units without any difficulty. Equally, the scope of the diagnosis can be changed for the individual control units.

Information which is relevant to the communication with the control units in the motor vehicle is available locally. This information can also be updated.

The remote diagnosis system is intended for use primarily in the course of visits to a garage. In this case, the diagnosis result data need to be transmitted from the vehicle (e.g., onboard system) to a garage system (e.g., offboard system) by means of a medium for short distances (e.g., WLAN). In this context, the vehicle can come into contact with various garages and hence various offboard systems over its life cycle. To safe-guard the onboard and offboard systems against access by unauthorized third parties, various methods for setting up connections are provided.

One possible method for setting up connections includes providing for an identifier to be interchanged between a garage and customer offline. When a garage and a customer first make contact, which happens before the actual service appointment, an identifier ID is delivered to the customer and can be input into the onboard system, (e.g. using a keypad in the motor vehicle interior). The onboard communication module is continually on reception standby. When the identifier has been input, it is then possible for a connection to be set up from the garage at any time using the identifier.

In another embodiment, a method for setting up connections provides for the arrangement of time windows within which a connection is set up. The garage's offboard system then continually attempts to set up a connection to an onboard system using the identifier (e.g. using a challenge-response method) only in the arranged time window. A correct onboard system can accepts the connection request based on knowing the identifier and therefore can react correctly to the connection request. The identifier becomes invalid following the transmission of the useful data. Other onboard systems do not accept the connection request, since they cannot respond to the connection request correctly.

In another embodiment, a method for setting up connections includes allocating, a unique identifier for each individual connection.

To protect the communication link, there an encryption method may be provided for data transmission if required. In this case, a key can be arranged and interchanged between the onboard system and the offboard system. Key arrangement and delivery can preferably take place together with arrangement and delivery of the identifier.

In one alternative embodiment, confirmation of the connection request can be visually displayed in the vehicle. This visual display can be produced by flashing three times on the left, by confirmation in a readable menu on an input terminal in the vehicle interior or by input of a vehicle-specific PIN (Personal Identification Number) code which is requested when the connection is set up.

In another embodiment, the requesting offboard system can transmit an identifier identifying the system. The identifier may be then valid over a relatively long period. The onboard system in the vehicle then has a request function for the history and remembers the identifiers of the last requesting offboard systems. These offboard systems may correspond to the service garages which are visited most and preferred by the customer. The offboard systems can be provided with access authorization by an authorizing identifier independently of another identifier to be arranged between the garage and the customer. When a known offboard system attempts to set up a connection, this is permitted by the onboard system without further confirmation in the vehicle.

In another embodiment, a specific identifier and possibly an actual key for safeguarding the data transfer may be stored in the vehicle during the vehicle production. The garages then receive a data packet (e.g., token) encoded using the key from a central diagnosis center upon request, or can regularly receive valid data packets for all vehicles. The data packet then contains the identifier for the access authorization, and an expiry date for the identifier or a time window for setting up a connection.

In another embodiment, connections are set up using dynamic identifiers and/or dynamic keys in which, there is an identifier and a key in the vehicle. The identifier may be known to a central diagnosis center. According to another embodiment, the identifier and the key are replaced by a new identifier and a new key after each visit to a garage such that, the vehicle, the current garage and the diagnosis center know the new identifier and the new key. The identifier and the key are replaced during the connection protected by the old identifier and the old key.

In one preferred embodiment of the invention, a WLAN connection in or on the service garage's parking area may be used for setting up a connection between the offboard system and the onboard system as shown in FIG. 1. A method is provided to meet the requirements for data protection and at the same time to prevent each customer from having to enter into an agreement with a service garage so that the data from the vehicle can be used by the garage, according to one embodiment.

The garage premises may be provided with specially marked parking areas in the vicinity of one another. For example, signs 10 can notify the customer that by parking in the specifically marked parking areas the customer agrees to evaluation of vehicle data. The garage's WLAN infrastructure, or transmission of position data for the parked vehicle within the vehicle data, allows only data from vehicles in these parking areas only to be displayed and processed further in the garage. To optimize the data transmission, the data from all vehicles may be transmitted to a garage system first of all. The data may then be processed further only when the customer's consent has been obtained through his parking the vehicle in a marked parking area. Otherwise, the data is deleted after a stipulated time. For setting up the a connection to the vehicles parked in the parking areas, the garage premises are fitted with appropriate transmission/reception installations (see S in FIG. 1) which allow the WLAN connection between the garage system and the vehicle. Position finding for the vehicles can be effected using induction loops in the marked parking areas. If the vehicle is equipped with a navigation system or with another GPS system, position finding can also be effected using a GPS system. The vehicle position is requested and checked in the offboard system.

The telediagnosis system may be in the form of an asynchronous or synchronous system.

In the case of the embodiment using an asynchronous telediagnosis system, the vehicle contains a complete diagnosis runtime system including all of the necessary data for at least this vehicle. The data may require updating for the entire vehicle fleet. The runtime system may be capable of implementing all the diagnosis options which also exist in the garage.

In the case of the embodiment using a synchronous telediagnosis system, the same hardware components and the same methods for setting up connections of an asynchronous system may be used. However, the synchronous telediagnosis system does not employ diagnosis jobs for the onboard diagnosis module. The individual diagnosis commands are sent from the offboard system to the control units in the vehicle. The result is forwarded directly to the offboard diagnosis module 29 by means of the control modules 20, 28 and the communication modules 25, 26. The offboard diagnosis module prepares the next diagnosis command and sends it to the onboard diagnosis module.

1. A method for transmitting diagnosis data from a vehicle to a customer reception in a service business, wherein:
an onboard vehicle diagnosis system for ascertaining, storing and transmitting is used to transmits said data from onboard components to offboard component;
a computer system in the service business, which has an offboard communication module, uses a dedicated channel of a radio interface to send a connection request to the ready-to-receive onboard communication module in the vehicle; and
the connection request is accepted by the onboard communication module only if a pre-arranged identifier is also transmitted when communication is set up.

2. The method as claimed in claim 1, wherein the onboard communication module is continually ready-to-receive.

3. The method as claimed in claim 1, wherein the onboard communication module is intermittently ready to receive after an identifier has been input for it.

4. The method as claimed in claim 1, wherein when a connection has been set up the onboard communication module wakes up the control units that are networked in the vehicle when a connection has been set up.

5. The method as claimed in claim 1, wherein as well as the identifier a time window for connection setup is also arranged.

6. The method as claimed in claim 1, wherein a unique identifier is arranged for each service appointment.

7. The method as claimed in claim 1, wherein the connection setup is followed by a second identifier being transmitted for the offboard communication module and being stored in the onboard communication module.

8. The method as claimed in claim 1, wherein an identifier is input in the onboard communication module when the vehicle is actually produced.

9. The method as claimed in claim 1, wherein the identifier stored in the onboard communication module is replaced by one or more new identifiers upon each service carried out.

10. The method as claimed in claim 1, wherein a WLAN connection is used for the connection setup.

11. A vehicle diagnostic system for ascertaining, storing and transmitting-diagnostic data from a vehicle to a customer service reception of a vehicle service business, the system comprising:
onboard components having a ready-to-receive onboard communication module; and
offboard components in the vehicle service business including an offboard communication module configured to send a connection request to the ready-to-receive onboard communication module in a vehicle over a dedicated channel of a radio interface,
wherein the onboard communication module is configured to accept the connection request only if a pre-arranged identifier is also transmitted during communication set up.

12. The vehicle diagnostic system as claimed in claim 11, wherein a time window for the identifier and connection setup is provided.

13. The vehicle diagnostic system as claimed in claim 11, wherein a unique identifier is arranged for each service appointment.

14. The vehicle diagnostic system as claimed in claim 11, wherein the offboard communication module is configured to transmit a second identifier following connection setup, wherein the onboard communication module is configured to store the second identifier.

15. The vehicle diagnostic system as claimed in claim 11, wherein the identifier is input in the onboard communication module during manufacture of a vehicle.

16. A vehicle diagnostic system for obtaining diagnostic data from a vehicle and providing the diagnostic data to a vehicle service center, the vehicle diagnostic system comprising:
an onboard diagnostic module to provide diagnostic data for one or more components of the vehicle;
onboard communication module configured to transmit the diagnostic data, wherein the onboard communication module is configured as ready-to-receive communication connection requests; and
a vehicle service center including an offboard communication module configured to transmit one or more communication connection requests over a dedicated channel of a radio interface, and an offboard diagnostic module configured to process and output the diagnostic data,
wherein the onboard communication module is further configured to accept a connection request only if a pre-arranged identifier is received during communication is set up.

17. The vehicle diagnostic system as claimed in claim 16, wherein the offboard communication components are configured to provide a time window to receive the identifier and to provide connection setup.

18. The vehicle diagnostic system as claimed in claim 16, wherein the offboard components are configured to provide a unique identifier for each service appointment.

19. The vehicle diagnostic system as claimed in claim 16, wherein the offboard communication module is configured to transmit a second identifier following connection setup and the onboard communication module is configured to store the second identifier.

20. The vehicle diagnostic system as claimed in claim 16, wherein the onboard communication module comprises an identifier received during manufacture of a vehicle.
